(19) United States
(12) Patent Application Publication
(10) Pub. No.: US 2016/0232613 A1
(43) Pub. Date: Aug. 11, 2016

(54) NETWORKED SERVICES VIA INTERMEDIARIES

(71) Applicant: Trader Eye Ltd., Givatayim (IL)

(72) Inventor: Meir HAZAN, Givatayim (IL)

(21) Appl. No.: 15/045,219

(22) Filed: Feb. 16, 2016

Related U.S. Application Data
(63) Continuation-in-part of application No. 13/774,716, filed on Feb. 22, 2013, now abandoned.
(60) Provisional application No. 61/601,566, filed on Feb. 22, 2012.

(51) Int. Cl. G06Q 40/04

(52) U.S. Cl. CPC G06Q 40/04

(57) ABSTRACT

A networked intermediary provides source information together with enhancements to an end user to combine or enhance the user's networked experience. Embodiments relate to a networked intermediary for search engines and a networked electronic information provision system for products with statistical complexity. The latter has a screen support system which provides to end users a three part screen, including an alert screen part, a trading screen part and a statistical screen part. The alert screen part provides users with current and past alerts regarding one or more products. The trading screen part provides a trading screen to allow a user to view and interact with current trading positions of one or more products and the statistical screen part displays statistical parameters relating to one or more products.

### CROSS REFERENCE TO RELATED APPLICATIONS

This application is a continuation in part of U.S. patent application Ser. No. 13/774,716, filed Feb. 22, 2013, which in turn claims priority to Provisional Application Ser. No. 61/601,566, filed on Feb. 22, 2012, the complete disclosures of each of which are hereby incorporated by reference.

### TECHNICAL FIELD

The present invention, in some embodiments thereof, relates to networked services via intermediaries and more particularly but not exclusively to intermediaries who modify the presentation but not the content of material from a source.

### BACKGROUND OF THE INVENTION

Today there are toolbars that may be added to Internet browsers that provide users with various kinds of assistance.

For example toolbars may provide a constantly available text box for providing search terms and then giving the user a choice of search engines to use.

The benefit to the makers of such toolbars is that the search engines then share with them revenues from advertising that is provided to the user together with the search results. The search itself is carried out by the chosen search engine and the toolbar providers neither can nor would be expected to add value to the highly resourced Internet Search Engines.

Financial trading information is provided from multiple sources on the Internet.

Financial derivative products exist to provide insurance to those who do business in the underlying product, and are widely traded through specific derivative markets and over the counter (OTC) directly between institutions.

Derivative price fluctuations are intently analyzed by economists as they often provide the first indications of future trading and financial conditions, and early signals are needed by the traders themselves.

Trading may involve hedging or speculation. Hedging involves using financial derivatives as insurance against a specific risk. Thus an institution based in Europe, and whose costs are in Euros, but whose sales are principally to the United States, so that income is in dollars, is at risk if the dollar falls and/or the Euro rises, so that the institution may wish to use currency hedging to insure itself against either of these two events.

Speculation involves taking positions of risk using derivatives, of the underlying asset, in the hope of making leveraged profits. Thus derivatives take on an aspect of being a mode of transferring risk from the risk averse to the risk takers.

Currency trading (Forex) is commonly carried out using currency derivatives, such as options or futures in the underlying currencies. An option or future specifies a date in the future and an exchange rate between two underlying currencies.

As well as currencies, share derivative trading may be made using derivatives of the underlying shares and commodities trading may be carried out using derivatives of the underlying commodities.

Derivatives in currencies, shares and commodities have the same aspects of a strike price, and an expiry date at some time in the future, but they tend to have different statistical behaviors. Derivatives further differ in whether the expiry date is the only date at which the derivative may be exercised, as in so-called European style options, and where the derivative may be exercised at any time up to the expiry date.

For hedging, instantaneous changes in prices are not of interest. The hedger has a certain amount of exposure to the underlying asset that it is desired to ensure for a given contingency which exceeds the risk he is prepared to live with. However the hedger does need to have a way of determining a fair price to a derivative.

For the speculator, the desire is to take a position that he can buy low and sell high, so that instantaneous price changing information and current statistical data of the underlying asset is vital.

With currency trading, news may be available that strengthens a given currency, but the news is not much help if the speculator cannot know which other currencies are also behaving strongly or which other currencies are behaving weakly. Thus even if I receive information that the dollar is behaving strongly, I will gain little if I purchase an option or future looking for the dollar price to rise against another currency that is also behaving strongly at the moment. Rather it is necessary to identify a currency that is currently behaving weakly.

Ways of assessing how strongly or how weakly currencies are doing are known, but these assessments are not available in real time and thus actual investment decisions are made on the basis of an individual news item plus an overall feeling, that is to say anecdotally rather than statistically. As the saying goes, an anecdote is not data.

Generally, even experienced traders, have a tendency not to cash themselves out of loss-making positions before the loss-making positions get worse, based on an often wrong assumption that an upturn may occur shortly. Having statistical information to hand would enable traders to assess more precisely whether a trend is likely to be short or long term.

Since the early 1970s, the Black Scholes equation, has been used to calculate option prices from a partial differential equation based on the assumption that there is a position which involves a long holding of the asset and a short holding of the derivative, whose value will not depend on the price of the stock.

The formula is difficult for private individuals to apply, certainly in real time, and even financial institutions doing OTC trades, often use accredited external individuals to provide pricings for the trades. Thus again, individual trades are based on single items of news, and feelings and not on the underlying statistics.

Overall, derivative trading is well understood theoretically. Yet the benefits of this theoretical knowledge are not available to the individual trader at the sharp end.

### SUMMARY OF THE INVENTION

Today there are toolbars that may be added to Internet browsers that provide users with various kinds of assistance.

For example toolbars may provide a constantly available text box for providing search terms and then giving the user a choice of search engines to use.

The benefit to the makers of such toolbars is that the search engines then share with them revenues from advertising that is provided to the user together with the search results. The search itself is carried out by the chosen search engine and the toolbar providers neither can nor would be expected to add value to the highly resourced Internet Search Engines.

Financial trading information is provided from multiple sources on the Internet.

Financial derivative products exist to provide insurance to those who do business in the underlying product, and are widely traded through specific derivative markets and over the counter (OTC) directly between institutions.

Derivative price fluctuations are intently analyzed by economists as they often provide the first indications of future trading and financial conditions, and early signals are needed by the traders themselves.

Trading may involve hedging or speculation. Hedging involves using financial derivatives as insurance against a specific risk. Thus an institution based in Europe, and whose costs are in Euros, but whose sales are principally to the United States, so that income is in dollars, is at risk if the dollar falls and/or the Euro rises, so that the institution may wish to use currency hedging to insure itself against either of these two events.

Speculation involves taking positions of risk using derivatives, of the underlying asset, in the hope of making leveraged profits. Thus derivatives take on an aspect of being a mode of transferring risk from the risk averse to the risk takers.

Currency trading (Forex) is commonly carried out using currency derivatives, such as options or futures in the underlying currencies. An option or future specifies a date in the future and an exchange rate between two underlying currencies.

As well as currencies, share derivative trading may be made using derivatives of the underlying shares and commodities trading may be carried out using derivatives of the underlying commodities.

Derivatives in currencies, shares and commodities have the same aspects of a strike price, and an expiry date at some time in the future, but they tend to have different statistical behaviors. Derivatives further differ in whether the expiry date is the only date at which the derivative may be exercised, as in so-called European style options, and where the derivative may be exercised at any time up to the expiry date.

For hedging, instantaneous changes in prices are not of interest. The hedger has a certain amount of exposure to the underlying asset that it is desired to ensure for a given contingency which exceeds the risk he is prepared to live with. However the hedger does need to have a way of determining a fair price to a derivative.

For the speculator, the desire is to take a position that he can buy low and sell high, so that instantaneous price changing information and current statistical data of the underlying asset is vital.

With currency trading, news may be available that strengthens a given currency, but the news is not much help if the speculator cannot know which other currencies are also behaving strongly or which other currencies are behaving weakly. Thus even if I receive information that the dollar is behaving strongly, I will gain little if I purchase an option or future looking for the dollar price to rise against another currency that is also behaving strongly at the moment. Rather it is necessary to identify a currency that is currently behaving weakly.

Ways of assessing how strongly or how weakly currencies are doing are known, but these assessments are not available in real time and thus actual investment decisions are made on the basis of an individual news item plus an overall feeling, that is to say anecdotally rather than statistically. As the saying goes, an anecdote is not data.

Generally, even experienced traders, have a tendency not to cash themselves out of loss-making positions before the loss-making positions get worse, based on an often wrong assumption that an upturn may occur shortly. Having statistical information to hand would enable traders to assess more precisely whether a trend is likely to be short or long term.

Since the early 1970s, the Black Scholes equation, has been used to calculate option prices from a partial differential equation based on the assumption that there is a position which involves a long holding of the asset and a short holding of the derivative, whose value will not depend on the price of the stock.

The formula is difficult for private individuals to apply, certainly in real time, and even financial institutions doing OTC trades, often use accredited external individuals to provide pricings for the trades. Thus again, individual trades are based on single items of news, and feelings and not on the underlying statistics.

Overall, derivative trading is well understood theoretically. Yet the benefits of this theoretical knowledge are not available to the individual trader at the sharp end.

### BRIEF DESCRIPTION OF THE DRAWINGS

The present invention will be understood and appreciated more comprehensively from the following detailed description taken in conjunction with the appended drawings in which:

FIG. 1 is a schematic diagram showing a server, source servers and end users, all networked together to provide a system according to the present embodiments;

FIG. 2 is a schematic layout of a split screen provided by the present embodiments at an end user;

FIG. 3 is a schematic layout showing in greater detail the split screen of FIG. 2 when in use;

FIG. 4 is a schematic layout showing the split screen of FIG. 2 with two divisions;

FIG. 5 is a schematic flow chart illustrating one way to obtain currency strengths according to the present embodiments;

FIG. 6A is a version of the split screen of FIG. 2 set up for a different product;

FIG. 6B is a simplified diagram showing a variation of the split screen of FIG. 6A to include a view of a trading room or trading floor, and a chat window, according to an embodiment of the present invention;

FIG. 7 is a simplified block diagram showing the embodiment of FIG. 1 with multiple source servers;

FIG. 8 is a simplified diagram illustrating a message-feed system for combining messages such as alert messages into separate feeds for users to select, according to an embodiment of the present invention;

FIG. 9 is a simplified diagram showing a message display system where the messages can be grouped or ordered according to an embodiment of the present invention;

FIG. 10 is a simplified diagram showing a modification of the trading part of a compound screen according to the present embodiments for allowing mirror trading by showing the trader to be mirrored together with the trading screen;

FIG. 11 is a simplified diagram showing a modified installer that installs the split screen as an enhancement to an existing trading screen, according to an embodiment of the present invention;

FIG. 12 is a simplified diagram illustrating a news alert shown together with trading options according to an embodiment of the present invention;

FIG. 13 is a simplified flow diagram illustrating a procedure according to an exemplary embodiment of the present invention;

FIG. 14 is a simplified diagram showing the relationship between user, main search engine and enhanced search engine according to an embodiment of the present invention;

FIG. 15 is a simplified diagram illustrating a variation of the embodiment of FIG. 9 in which a company Intranet links the user to the Internet and the enhanced search engine is part of the company Intranet;

FIG. 16 illustrates a standard window showing search results received from an Internet search engine; and

FIG. 17 is a simplified diagram illustrating a window with both regular and enhanced search results according to an embodiment of the present invention.

### DETAILED DESCRIPTION OF THE INVENTION

The present invention, in some embodiments thereof, relates to enhancement of Internet activity by use of intermediaries between information sources and final users.

A general embodiment of the idea relates to searches and search engines, and a further embodiment relates to real time information provision for products with statistical complexity and, more particularly, but not exclusively, to a system for providing real time statistical, analysis and alert-type information over a network in a way which is manageable and readily understandable to the user.

In the general embodiment, a main search is carried out in the normal way through a standard search engine. As the results are retrieved from the main search, the browser screen that displays the results shows in its title bar the name of the search engine used and the key-words that were used in the search. An applet continuously checks title bars of windows, especially of active windows, in order to detect searches. If the applet finds the name of a search engine then it looks for the keywords. Any key words it finds are then submitted to its own search engine and then the results are shown in a side bar.

An intermediary platform using another embodiment of the present invention may provide a user with a screen showing at the same time different types of data regarding a product to be traded, on a split screen, the information being news or change-type data such as alerts, on an alert screen, a trading screen itself, showing the products to be traded and current offers and bids, and a statistical screen, showing statistical information about the product. Additional parts of the screen may indicate which exchanges are currently open for trading.

The alert screen may initially provide an alert header and then have separate screen parts for an alert body and an alert footer. A folder may store historical alerts for any given product, so that a user can select a product and see selectable headers of past alerts.

The statistical screen may provide indicators for the given product or for a range of products that are traded against each other. Thus a series of statistical indices for different currencies may be shown next to each other so that the user can then select to take a position between a currency that is currently strong and a currency that is currently weak.

A further embodiment comprises a method of enhancing an Internet activity such as a search by identifying key words used in the activity and submitting them for a search. In one example the main activity is itself a search. The key words used in the main search are submitted for a search which is different in scale, perhaps more localized geographically than the main search, so as to provide results which have a different kind of relevance from the main search.

The main search is carried out in the normal way. As the results are retrieved from the main search, the browser screen that displays the results shows in its title bar the name of the search engine used and the key-words that were used in the search. An applet continuously checks title bars of windows, especially of active windows, in order to detect searches. If the applet finds the name of a search engine then it looks for the keywords. Any key words it finds are then submitted to its own search engine and then the results are shown in a side bar.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

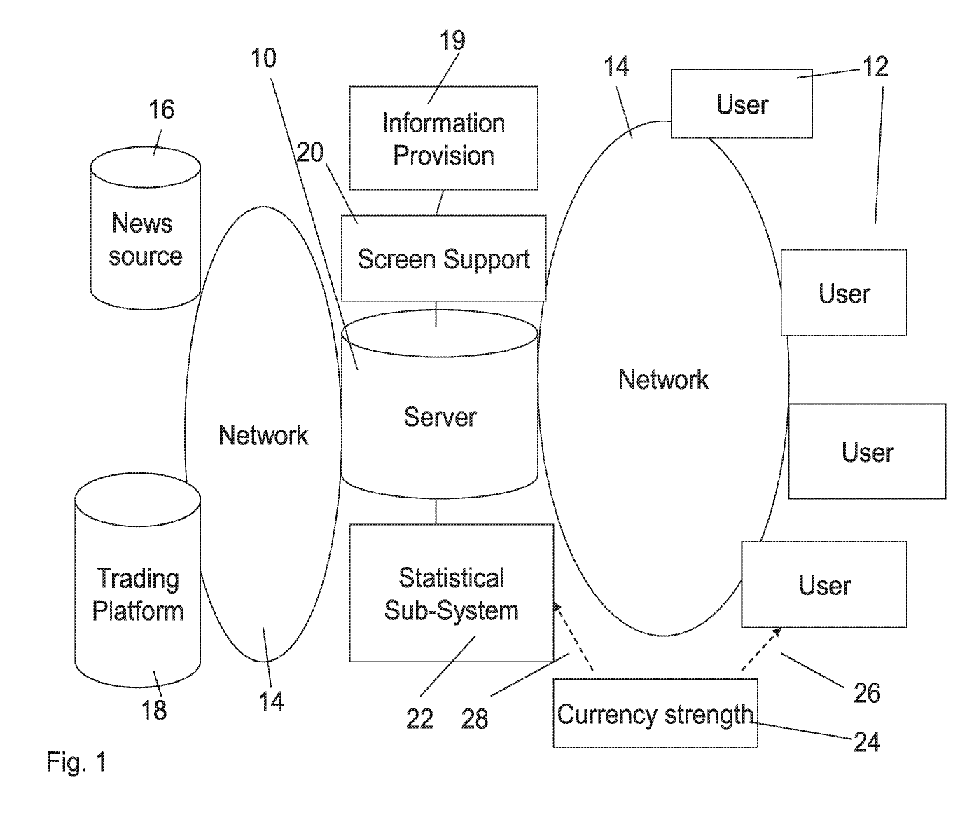

Referring now to the drawings, FIG. 1 illustrates a networked electronic information provision system for products with statistical complexity. Networked server 10 is connected to users 12 via a network 14 and may be connected to a news source 16 and a trading platform 18. The server supports the information provision system 19 which in turn includes a screen support system 20. The screen support system manages information received and arranges the information for a split screen arrangement at the end user. The screen support system provides to each end user a three-part screen, or a screen with more than three parts.

A statistical sub-system 22 may be provided with the server in order to provide real time calculations of statistics for the various products. Alternatively, statistics may be obtained over the network or calculated at the end user based on data received from the various feeds.

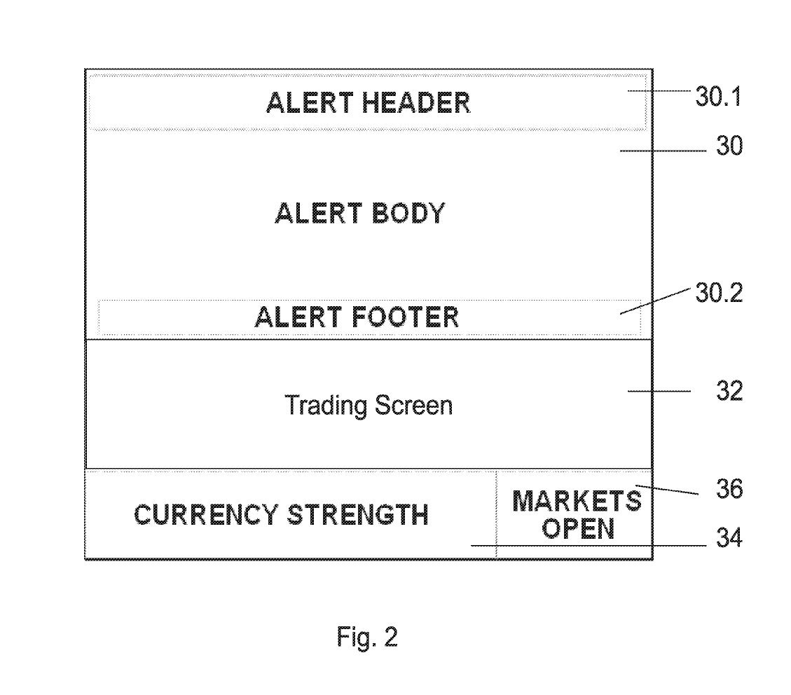

Referring now to FIG. 2, the three-part screen that the screen support system provides to the end users comprises an alert screen part 30, a trading screen part 32 and a statistical screen part 34. The alert screen part may include a header field 30.1, for alert headers, as well as a footer field 30.2 for alert footers.

The alert screen header 30.1 optionally includes a selector module, configured for selecting a given financial product. The alert screen part may provide users with current and past alerts regarding one or more products. The specific product focused on may be chosen directly by the user, or the user may choose to focus on a particular class of product, in which case he/she may receive all alerts relating to instances of the class of product. Thus if he/she is doing currency trading he may receive alerts relating to the full range of currencies available for trading, or a user selected range of currencies or a default grouping of major currencies. If trading in options on shares the alerts may relate to specific shares being traded in plus general alerts relating to the specific market. At the very least different end users may each focus on products or product classes of their own choosing so that individual users all see different information.

The alert screen 30 may comprise a feed from the networked business news source 16. Alerts may be provided from more than one source. The different sources may each have their own look and feel, the logo and jingle of the provider for example. The different look and feel are helpful to users to distinguish between different sources on fast moving screens. Different alerts may be obtained from different kinds of sources to provide users with different kinds of data. Thus news alerts may come from a news source, raw price data may be obtained from a signal source, that is a source that provides current market prices, charting data and buy and sell signals may come from a charting source, that provides analyzed price data, and alerts may also be obtained from a risk management source. News alerts may include announcements, on the hour news bulletins, anticipations of price moves, special reports, pair-of-currency analysis or other kinds of analysis, cycle time information, technical alerts, trend information and geopolitical information.

Alerts may be provided with follow-up messages at a given time interval later. Thus a forecast for a particular currency move over the following week may be followed up by an assessment at the end of the week.

Follow-up messages may be provided from the same source as the alerts themselves. Alternatively the follow-up messages may be provided by the present system, with a system administrator marking alerts for follow-ups at predetermined intervals. The user client may be able to show alerts together with their follow-up messages, and when the message and follow-up messages may be marked as being connected both to original alerts and to earlier follow-up messages of the same alert.

The trading screen part may provide a trading screen to allow a user to view and interact with current trading positions of a selected product, which may or may not be the same as the product selected for the alerts.

The trading screen may comprises a feed from a networked trading platform 18, such as the MetaTrader 4 (or MT4)™ platform. The trading screen may give the user's current real or simulated position together with current sell and buy information of specific products.

The trading screen may include more than one account. Individual users may have separate accounts with the same provider or with different providers. The different accounts may be shown on the same trading screen, either one under the other with scroll bars or in divided parts of the trading screen.

The statistical screen part presents one or more statistical parameters relating to a further selected product which may or may not be the same as that selected in the previous screens. Where the products are options, the statistical parameter may be an option Greek, one of the parameters typically used by options traders to understand the behavior of the option in light of the underlying product. Alternatively the parameter shown may be a result of the Black Scholes equation or various derivatives or improvements of the Black Scholes equation.

Alternatively, if the product being traded is currency, then a statistical parameter indicating the current strength of the currency or the stability of the currency may be shown, or the interest rate or an expectation of change in the interest rate or any other parameter that may be considered as helpful in understanding the strength of a currency. In one embodiment, the strength of the currency is expressed as an indicator over a scale of 0 to 10.

In currency trading, the challenge is to select two currencies to trade against, one currency that is strong against another currency that is weak. Typically users obtain a signal that a particular currency is doing well or badly but the problem is to know which other currency is going in the opposite direction for them to trade against. Showing the series of currencies simultaneously solves the problem. The user can see at a glance which currencies can be paired off to trade against.

As well as showing strong and weak signals for currencies as such, it is also possible to show strong and weak signals for currencies against precious metals such as gold and silver, so-called XAU and XAG signals, where X may be any currency. The value of the precious metal may go up and down, but the ability of a trader to profit from it may depend on which currency is used to invest in the gold. Today, professional traders who deal in precious metals use multiple screens to determine the currency that is most suitable for metal trading, but the private trader has no means of obtaining this kind of information, certainly not in real time. The present embodiments acquire trading strength signals for the precious metal as well as for the individual currencies and connect the two together to show the strengths of the currencies relative to the metal.

In general, statistical analysis is valid as long as there is reasonable stability in the market as a whole and for the particular product in question. However occasionally some form of major instability occurs, possibly due to an unforeseen external factor, possibly due to internal forces of the market itself. In such a case the system allows for additional parameters to be included in the statistical analysis, including parameters that are entered by hand.

The screen support system may support a fourth screen part 36 indicating markets that are currently available for product selection. The fourth screen part may show which markets are open at the present time from one or more of the following markets: US, Europe—as a whole or looking at specific markets in Europe, Asia—as a whole or looking at specific markets in Asia, Japan, Hong Kong, Singapore etc.

The fourth screen part may be coded to standard market opening hours, and/or may automatically take into consideration all actual/non-standard/exceptions including daylight saving times, national holidays, etc.

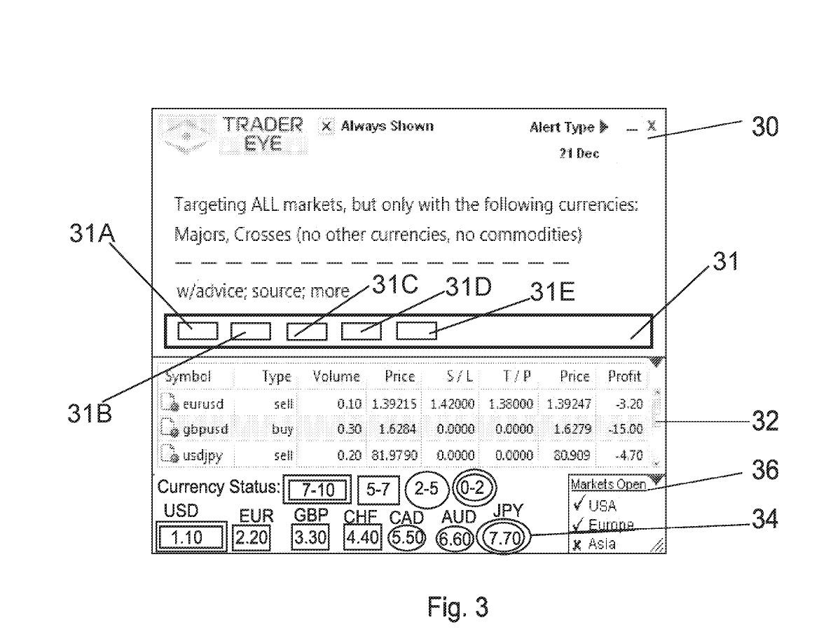

Reference is now made to FIG. 3 which is a screen shot of an example of the split screen shown in FIG. 2. Parts that are the same as in FIG. 2 are given the same numeral. As shown in FIG. 3, additionally to the alert screen 30, the four-part screen of the screen support system includes timeline indicator 31, which optionally includes a plurality of tabs 13A, 31B, 31C and 31D, typically provided underneath the alert screen part 30 to allow the user to archive different alert messages according to headings and be able to find them later on with ease. The top section of the window may include an announcement of the latest alert, with the tabs being present on the lower part of the screen. Clicking on a given tab may lead to a lower level of tabs. As desired by the user, alerts may be added to tabs in order of receipt or in order of subject or in order of product or exchange or in multiple levels based on any of these or other criteria. Messages may include links to older message or more messages on the particular subject, which links may originate from the message provider or from the user.

The product class being traded on FIG. 3 is currency. Currencies are traded against one another and thus the statistical screen part 36 displays further products traded against the selected product, in other words other leading currencies. In general, trading platforms available today provide up-to-date offer and bid prices on a product as well as basic details of what the product is. The screen shows the user's position with respect to the produce and may allow for a link to another platform that may have more comprehensive information on the product, including statistical information. However news and alerts are not provided on trading platforms and statistical information is not provided simultaneously with the trading screen.

The present embodiments provide for an alert screen part 30, which may comprise a window that jumps up on a part of a screen to show news messages. The messages may comprise news, analysis, and announcements about recent movements in relation to the product. Alerts may include feeds from a news source, as well as price alerts set by the user himself.

News providers such as Reuters and Bloomberg provide alert signals as well as trading advice. Another provider is the Trader Eye Drupal™ server The alert window may be a mirror of the website of the news provider, so that the window simply provides the news site simultaneously on a split screen with the trading window, and everything that appears in the window part may also appear at the provider's site.

The system may further include an archiving portal where all transactions and transaction times are recorded under third party supervision, so that details of trading problems can be made available for legal action, forensics etc.

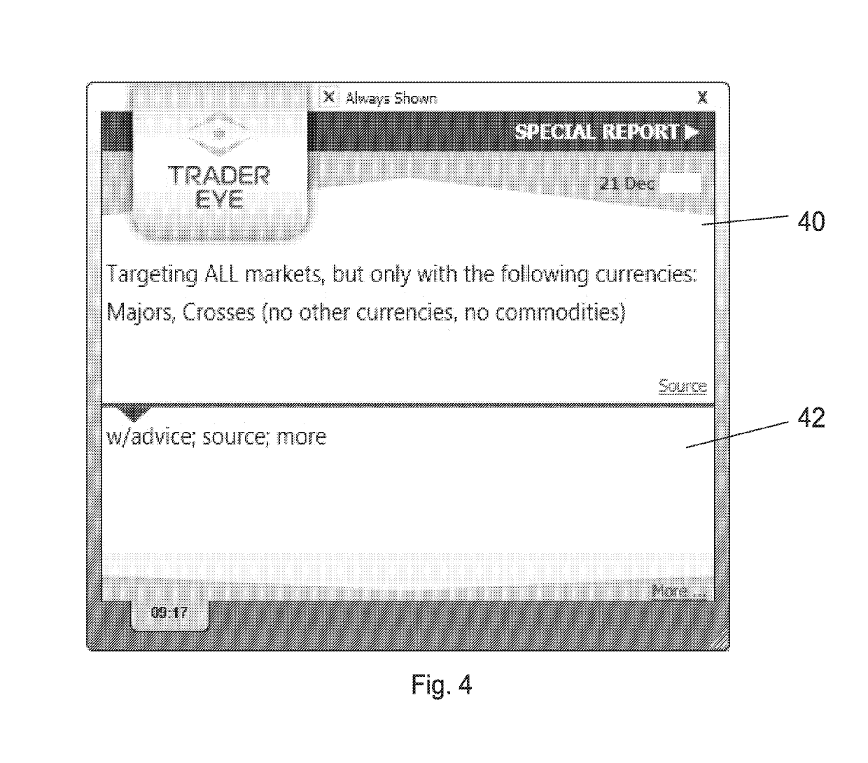

FIGS. 3 and 4 show screen shots of a design for the split screen arrangement. FIG. 3 shows four screen parts together, as discussed. FIG. 4 shows the design for the alerts area itself being divided into two screen parts but without the content. An upper screen part 40 may include the content of an alert, and the lower screen part 42 may include accompanying commentary from the provider. The arrangement is suitable for news providers who provide information in the format of an alert item plus separate commentary or advice. On the provider's own website such information may be provided as a headline plus content, however two separate screen parts are considered more appropriate when the information is to be shown together with other screens.

The window may have a standard/default size and may or may not include a very limited amount of advertising. End user clients support small/standard/large sizes and permit resizing.

The open markets sub-window 36 may connect to a clock showing absolute time or time at different locations or time to close of the specific market. The user may be able to define which markets are shown in the sub-window.

The alert part of the screen may be dedicated to dynamic alert content from one of the business news feed companies, as discussed above. The feed content may be used as provided or may be modified for use with the split screen system.

In an embodiment, several news sources may be used and the user may be able to configure which, if any, he wants. Likewise the user may be able to configure the subjects for which he requires news feeds. A menu may include subjects or sources, with sub-menus for more specific subjects.

The trading window may show trader positions including both open and pending positions. The position data may be retrieved from a trading platform client currently operating at the user's computer or directly from the trading platform server.

That is to say, the trading screen part may be based on the regular user client of the relevant trading platform, and queries to the API thereof, or by querying the server API. Alternatively the trading screen part may simply run an instance of the trading platform within a defined window alongside the other screen parts.

In the query version, the screen support mechanism may ask questions of the API regarding the user's current position or regarding products that the user desires information about, so that communication is via the API of the trading platform.

Content retrieved and displayed on the trading screen is shown in TABLE 1.

TABLE 1
Content shown on the trading screen

| Content retrieved | MT name | Alert name |
|---|---|---|
| Symbol | Symbol | Symbol |
| Position type (buy/sell) | Type | Type |
| Position size | Volume | Size |
| Position entry price | Price | E. Price |
| Stop Loss (SL) | S/L | SL |
| Take Profit (TP) | T/P | TP |
| Current market price | Price | C. Price |
| Current profit/loss | Profit | P&L |
| Current profit/loss | — | Pips |

TABLE 2 shows how the screen may appear when showing a user position in currency trading.

TABLE 2
User position in currency trading

| Symbol | Type | Volume | Price | S/L | T/P | Profit |
|---|---|---|---|---|---|---|
| EURUSD | Sell | 0.10 | 1.39215 | 1.42000 | 1.38000 | −3.20 |
| GBPUSD | Buy | 0.30 | 1.6284 | 0.0000 | 0.0000 | −15.00 |
| USDJPY | Sell | 0.20 | 81.9790 | 0.0000 | 0.0000 | −4.70 |

In a split screen situation, the trading part of the screen has less space than it would otherwise. This makes it difficult to display a complex position combining multiple products and make the position understandable at a glance.

Some adaptations include the following. If more positions (open & pending) are required in the position screen than there is available space, navigation through positions may be provided through vertical scroll. As an alternative, tabs may be used.

Positions may be sorted by smallest distance in pips from the stop loss SL or transaction price TP first, and then again for pending positions. Positions which are less than ten pips from TP may for example blink in green; otherwise, if the position is less than 10 pips from SL it may blink in red.

Pending positions which are less than 10 pips from entry may blink in blue.

The trading and alert windows may be provided from different sources having different membership conditions. Thus the system may support collapse of one or other of the screen parts for which the end user does not receive data, to give more space for the other screens.

The statistical sub-window may show currencies, as in FIG. 3. In this case the different statistical parameters may be translated into a color to indicate the strength of the given currency on a scale of 0-10. For example a color allocation for the scale levels may be as follows:

Cell background color coding may be:

RED—weak (0.0.about.2.0)

ORANGE—normal (2.1.about.5.0)

YELLOW—strong (5.1.about.8.0)

GREEN—critical (8.1.about.10.0)

The currencies shown may be configured by the user. A management interface may provide content configuration of both the selection and the order.

A number of ways may be used to assess the strength of currencies for the scale. Each formula considers strengthening and weakening between a number of currencies through the corresponding exchange rates. The calculation may be made according to different time bases, say week, day, hour or minute.

The calculation may involve charting, and thus charting phenomena such as the breaking of a support line, whether on an intra day, or a daily or a weekly or a monthly basis may be used to influence the currency strength calculation.

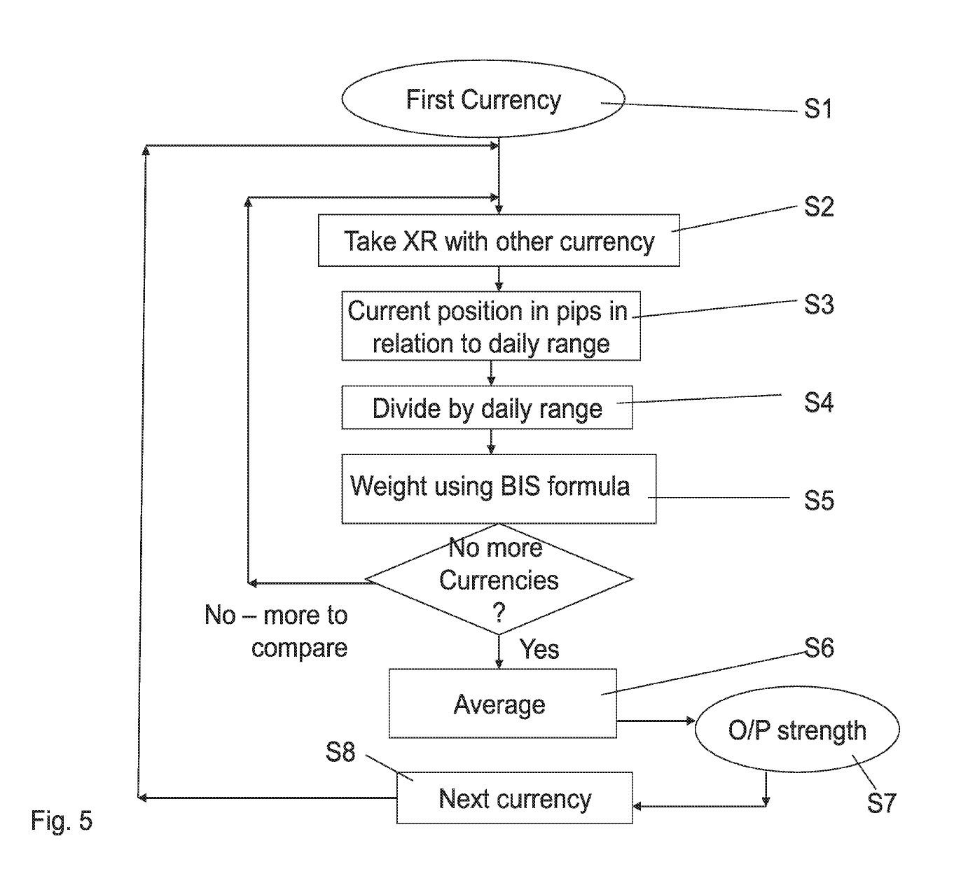

Reference is now made to FIG. 5, which illustrates how a currency strength calculation may be carried out by the currency strength calculator 24. Currency strength calculator 24 may be a part of the statistical sub-system 22, or may be provided at the end user. Dashed arrow 26 shows the currency strength calculator as part of the end user, and dashed arrow 28 shows the currency strength calculator as part of the statistical sub-system 22.

If the currency strength calculator is provided at the end user, then it generally only calculates strengths for currencies of interest to the given user. If the currency strength calculator is provided at the statistical subsystem then it may carry out all the calculations needed for all currencies presently of interest.

In one embodiment, the currency strength calculator is placed partly at the statistical sub-system and partly at the user. At the subsystem, strengths for the eight or so major currencies and any other currency undergoing a special event are calculated. At the user, strengths for non-standard currencies of interest to the individual user are calculated.

There are two loops in the calculation, an inner loop that calculates a figure for the strength of a given currency against a predetermined set of other currencies, typically the seven or eight major currencies, and an outer loop that continues to repeat the process to determine the strength of each of the other currencies in the set.

In the Example a first currency is taken in stage Si. The first currency is paired with each other currency in the set in turn, 52, to obtain the respective exchange rate XR. In S3 a current position in pips in relation to the daily range is taken for the exchange rate. Thus, if EURUSD is at 1.4500 and the daily range is 1.4450 to 1.4550, the current position in pips would be 50.

Then, a daily high-low is calculated in S4. The daily high-low is the Daily High/Low range for the currency pair. If the EURUSD's low is 1.3450 and the high is 1.3550, the daily range would be 100. For standardization purposes, the daily range may typically be calculated from 5:00 pm EST to 4:59 pm EST 24 hour period, the standard day for the Forex market.

In S5 the current position and daily high low are then multiplied using the BIS Weighted Formula. The BIS weighted formula is the Bank of International Settlement Forex volume distribution list. The formula provides weightings to the above raw figures.

The process is then repeated for every pair that contains the currency of interest. For instance, the reading of EUR will require the meter to repeat the process 7 times: EURUSD, EURGBP, EURCHF, EURPY, EURAUD, EURCAD, EURNZD.

As a final step S6, an average reading is taken by dividing the result by the number of pairs, typically seven if dealing with the eight major currencies. The result is then output to the currency strength window, S7.

The process is repeated for all eight major currencies—and any minor currencies of interest, S8. It is noted for completeness that the naming convention is used to distinguish between reverse calculations. Thus at any time a currency can be either the base or quote currency in a pair, thus, USD is the quote currency in USDPY, but the base currency in EURUSD.

In the above, it is noted that each calculation and its reverse are both required. Efficiency may be improved by saving each calculation and simply using its reciprocal for the reverse.

The currency strengths as calculated above may be provided as base strengths. The strengths may then be altered by the dynamics of the currency movements. Thus for each currency, it is well known to define trend lines. Trend lines, such as support and resistance lines, are based on the long term trend of the currency movement. Different support and resistance lines may be calculated for different time periods, thus intra day, day, week and month. A breakout from a support or resistance line—indicating an action of the currency which is contra to its long term trend, may be taken as a sign of strength or weakness and may be used to modify the scale as calculated above.

Thus, if a support line is broken on a particular day in the week, the system may allocate, to the currency, additional points on the scale. In one embodiment the same breakthrough is given different points on different days in the week, particularly being seen as more significant if occurring earlier in the week.

The rate of the breakthrough, a derived statistic, or as referred to below a metastatisic, is also important. A currency may pass a support line upwards very rapidly but then slow down upon reaching the resistance line. If so the currency is considered as weakening, probably not break through the resistance line and is not awarded too many points. On the other hand, if the currency retains its original rate, and the trend does not diminish upon approach to the resistance line, then the resistance line may most likely be crossed, and the currency is given an additional strength rating.

If the same currency breaks trend lines against multiple other currencies at the same time then a significant event may be flagged up. An extra indicator under the name of the currency may be provided to show that a significant event is occurring, and a rapid approach to resistance lines across multiple currencies could be of considerable importance and should be indicated.

In trials, the currency strength calculator managed between 100 and 200 calculations per currency trade reading. The currency strength calculator has the advantage is that it can pinpoint the best pair(s) to trade between by identifying both weak and strong currencies.

If a special event such as a decision on interest rates is expected with a given currency, such may be flagged by the system. If the event involves a minor currency, then the system may temporarily add minor currencies to the display when such a special event is scheduled, so as to indicate the opportunity to the user.

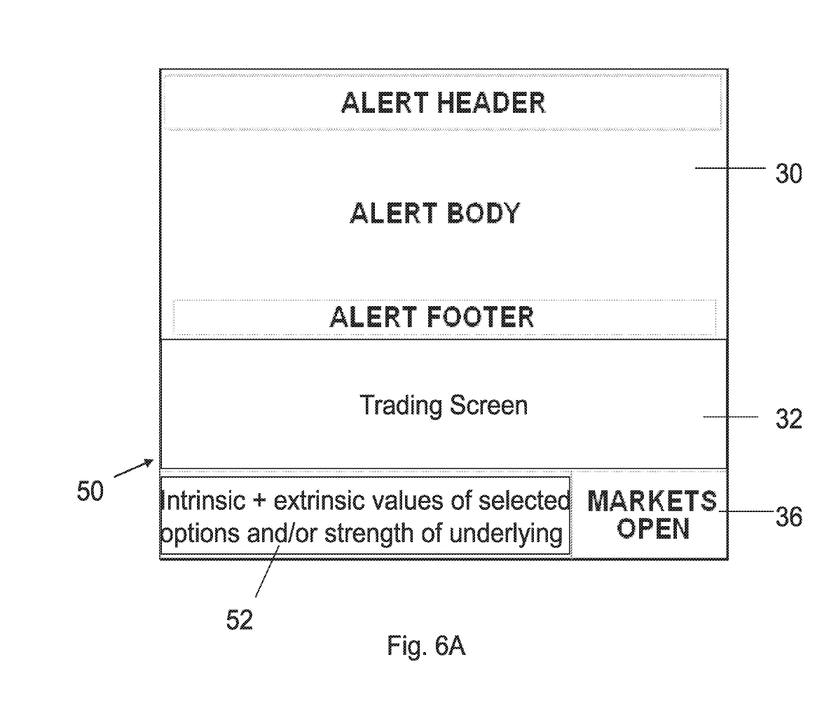

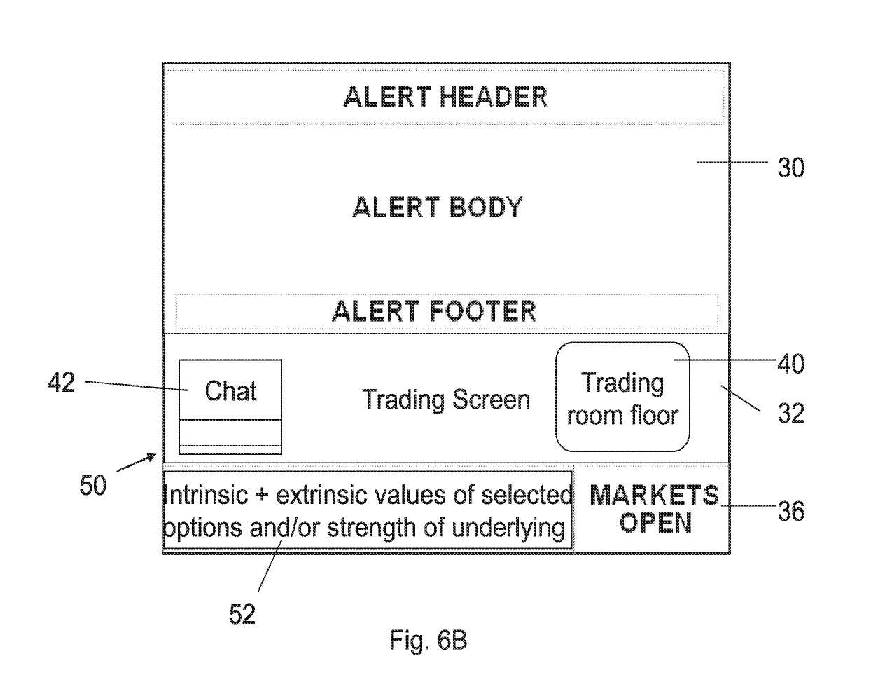

Reference is now made to FIG. 6A, which is a simplified version 50 of the screen of FIG. 2 adapted for trading of options. Parts that are the same as in FIG. 2 are given the same reference numerals and are not discussed again except as needed for an understanding of the present embodiment. Options have an intrinsic value based on the Black Scholes equation and an extrinsic value based on the underlying product. The statistical screen part 52 may thus include information about the intrinsic or extrinsic value parts. Alternatively the screen part may include statistical data about the option known as the option Greeks, referred to above, which are in effect statistical data of the option or of the relationship between the option and the underlying product, or of the underlying product itself.

Again the statistics of the underlying product may be scaled from 0 to 10 with different colors being applied to different levels of the scale.

Reference is now made to FIG. 6B, which shows a further modification of the screen of FIG. 6A. One issue is that of the trading room or trading floor. The trading floor is a central location in which the various currency or commodity trading is managed and where offers and acceptances are matched. In today's electronic trading brokers no longer approach jobbers with orders penciled on notepaper, but there is still much significant activity that takes place on the trading floor, including important financial announcements, graphs of freshly calculated statistics being shown etc, and traders often require a view of the trading floor. Views are typically provided to users through their browsers from cameras at the trading floor, but cannot be seen simultaneously with the trading screen.

The present split screen technology allows a view 40 of the trading floor to be shown together with the market screen, so that the user can see both his/her trading position and the floor screen at the same time.

Multiple trading floors around the world may be provided on a menu, and the user may simply select the trading floor required.

A further feature provided by the split screen support is a messaging screen part 42. An interactive messaging facility may be displayed simultaneously with the other screen parts, allowing the trader to chat with other system users. Alternatively, the system may co-opt a messaging facility from an external body, such as a chat feature from a social networking site or the like.

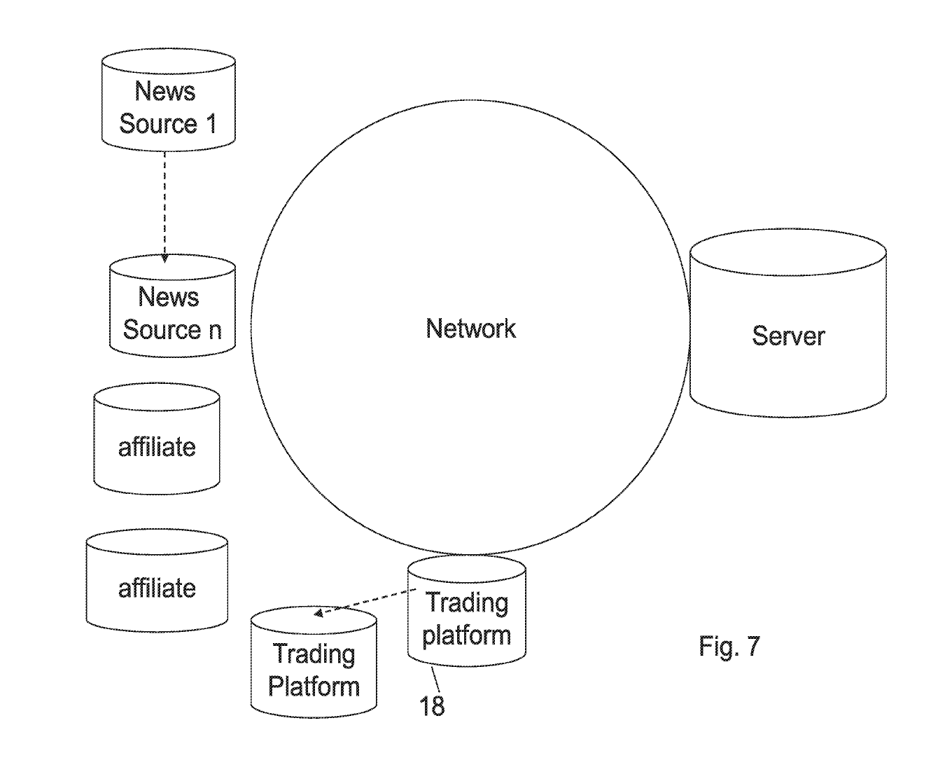

Reference is now made to FIG. 7, which is a block diagram showing in greater detail the source servers of the embodiment of FIG. 1. Networked server 10 may be connected to a range of news sources 16.1-16.n and affiliates, all providing different kinds of news relating to trading. In addition a range of trading platforms 18.1 to 18.n is in practice available. An individual user may subscribe to one or more news or affiliate services and may obtain on his split screen each of the services he is subscribed to. The user is able to customize his news view as discussed above.

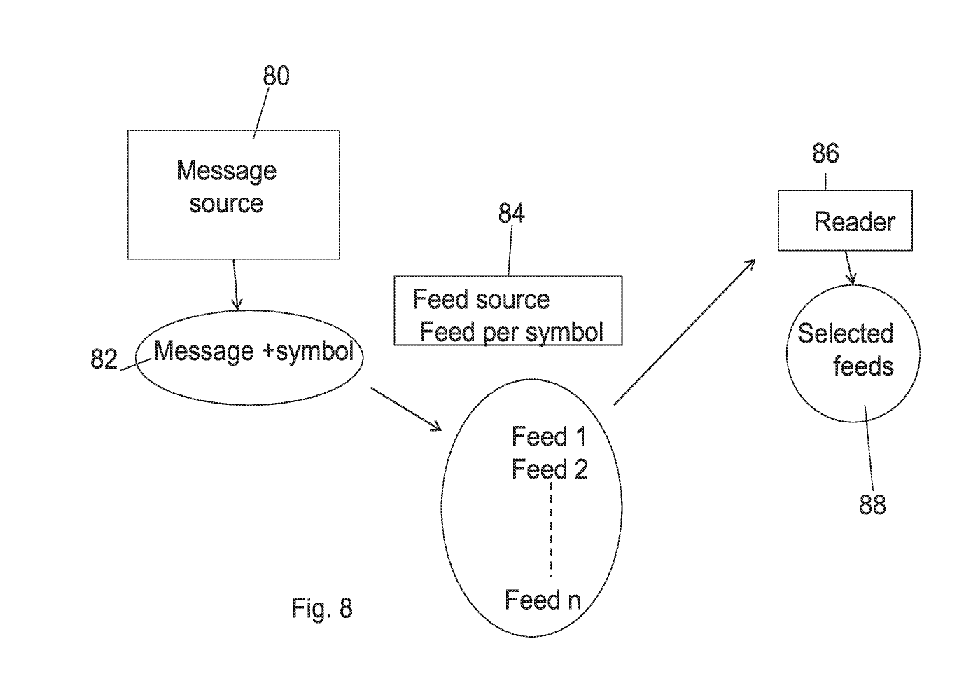

One convenient way to provide news is via an RSS feed. A user may customize the announcement part of the screen to accept RSS feeds of his choice in different ways, as will be discussed in greater detail in reference to FIG. 8.

Likewise an individual may trade on one or more trading platforms and will see his positions on any of the relevant trading platforms.

Reference is now made to FIG. 8, which is a simplified diagram illustrating a news feed according to embodiments of the present invention. As discussed above, users can easily be overwhelmed by too much information. Thus the present embodiments provide a way for concentrating only on the most relevant information. The news sources typically provide numerous announcements and a trading floor may typically release two hundred announcements per hour, each relating to different assets or derivatives of assets, or indices, or different statistical parameters. Thus an announcement may relate to a given market index, or a given share or a given currency or a given derivative product. Any of the above has a symbol, which symbol may be provided with the announcement. In the system of FIG. 8 a message source 80 is a source of numerous news messages 82, each message having a subject indicated by one of the set of symbols. In fact many news items may relate to multiple subjects and be associated with multiple symbols.

A feed source 84 provides a news feed (feed 1, feed 2, . . . feed n) for each symbol. Each message issued by the message source is identified and placed into a feed corresponding to the particular symbol or symbols associated with the message.

News feed clients 86 may then connect over a network to the feed source 84. The user selects feeds of interest 88, typically by clicking on the particular symbol, and then receives only those messages belonging to the subjects of interest.

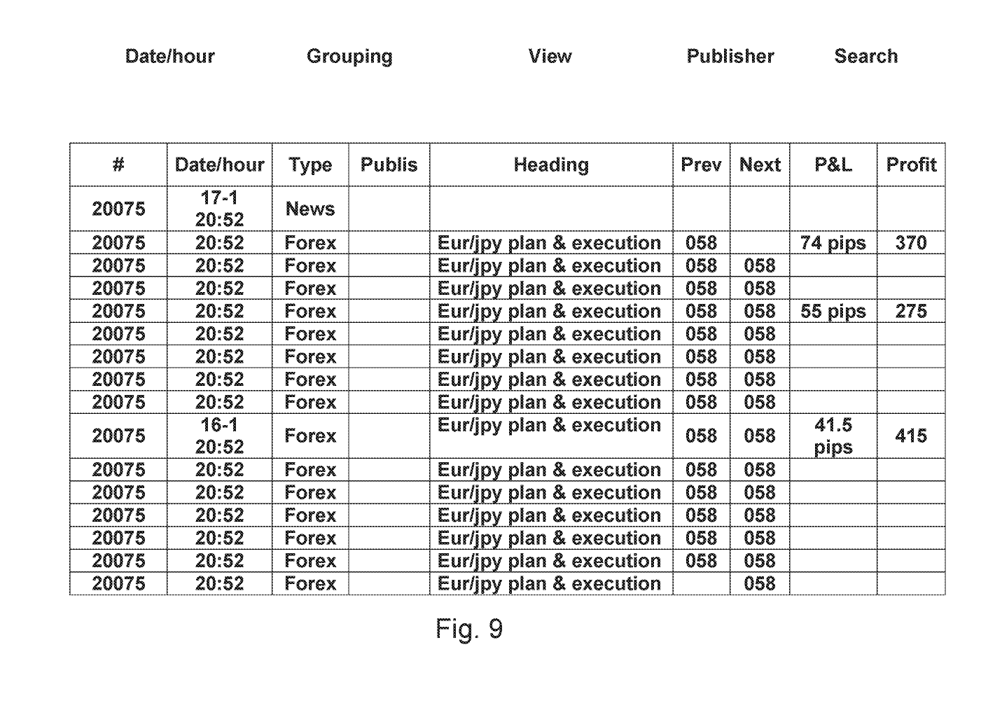

Once selected, the news items can be displayed in various ways. Reference is now made to FIG. 9, which is an exemplary screen showing an item of type “news” sorted together with various Forex trading items. The news items can however be shown without other types of items, and can be grouped together—say all news items belonging to a particular symbol are shown together. Alternatively all news items from a given publisher could be shown, or the news items could be sorted according to subject and publisher together, etc.

Each message box may then include all messages from a given publisher, or all messages regarding a given index etc. Within the message box, the messages may be shown in order of receipt, or grouped according to subject or in any other suitable way.

The news feed may be provided in the form of a rich site summary (RSS) feed, in which case the news feed clients would be RSS readers. Users may for example be charged on the basis of the number of feeds they use, and the messages provided may then remain in the user's history for future reference.

Source material relating to the news messages may be inserted into the feeds via links.

Referring again to FIG. 1, and the statistical sub-system 22 may continually calculate a range of statistical parameters relating to the indices, shares, currencies commodities and derivatives of the financial markets as discussed. In addition, the statistical subsystem may calculate or obtain metastatistical parameters relating to the statistical parameters themselves. Metastatical parameters, or parameters about the statistical parameters typically contain measures of success of the underlying or base statistic.

There are today organizations that provide charting. All kinds of statistical and metastatistical signals are provided but with multiple hundreds of signals per hour on a single market the trader may drown in too much information. Furthermore different charts may be to different scales or calculated in different ways, making comparison difficult. The present embodiments attempt to relate the metastat stics to the underlying statistics in order to display to the user only a subset of signals that appear to be important. In an embodiment it is possible to give different statistics a success rating and to relate to only those statistics which have a high success rating.

In an example given above, a certain share price may pass a support line and then approach a breakout position. Looked at without further analysis the approach looks like a good sign that the share price will break out. However a metastatistical parameter may measure the rate at which the share price passes the support line and compare that with the rate at which the same share price approaches the breakout position. If the rate of change falls it may be understood that the share price is losing momentum and will not actually break out. On the other hand if the rate of change increases then it may be apparent that a breakout really is imminent. Thus, in the present embodiments, only in the case of high momentum is the potential breakout considered important and passed on to users to be indicated in the statistical sub-screen, perhaps by causing the currency, index or commodity etc concerned to flash.

The statistical sub-system is thus able to use metastatistical parameters or derivations of basic statistics, to sort apparent signals on the basic statistic into important and unimportant signals. The statistical part of the screen can then concentrate on the important statistic and not drown the user in lots of irrelevant signals.

The existing systems simply provide all of the statistics. In the above example the trader could explicitly configure the existing system to display the approach to a breakout only in the case where the momentum of the approach is increasing. However the trader is left to his own devices on this point and would have to do the same thing for every other statistic provided. The chartists have the necessary information buried within their data, but the drill-down necessary to discover the information is a heavy burden on individual traders.

In fact, even for signals that are clearly understood as good signals, other factors such as the time of day, or the time of the day compared with the day of the week, may have an effect on how the signal can be used. For example at a certain time of the day, increase in momentum signaled by a fifteen minute graph may be important. At other times of the day, when trading is generally heavier, looking at a five minute graph may be more important. An example was given above in which greater importance is attached to currency rate rises towards the beginning of the week than towards the end of the week.

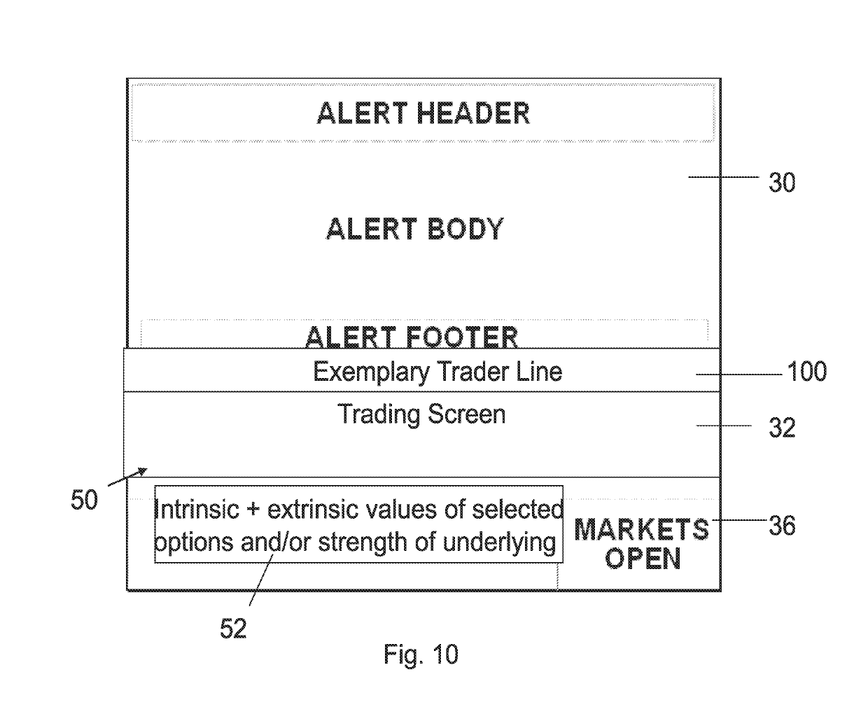

Reference is now made to FIG. 10, which shows a variation of the screen of FIG. 6 for mirror trading. Mirror trading is a system in which certain successful traders provide their trading details to other traders, typically for a fee. Other traders are able to see the trading screens of the successful traders in place of their own screens and they can then make their own trading decisions based on the successful trader. The problem with the conventional system is that traders spend most of their time watching their own positions and generally miss the actions of the trader they intend to mirror. By the time they notice the trade the price may have already moved by a sufficient amount to ensure that they are unable to benefit from the mirror trading, or are taking on the same position with much higher risk. The present embodiments solve the problem by providing the expert trader's most recent move as a line on their own trading screen. That is to say, the trading screen part 32 of the overall screen is modified to include trading lines 100 from the selected exemplary traders. The result provides single screen mirror trading, and allows the followers to react in real time to the trader they are attempting to mirror.

In a variation, the statistical sub-system may award points to all traders depending on their trading performance, and then provide recommendations as to which traders to mirror.

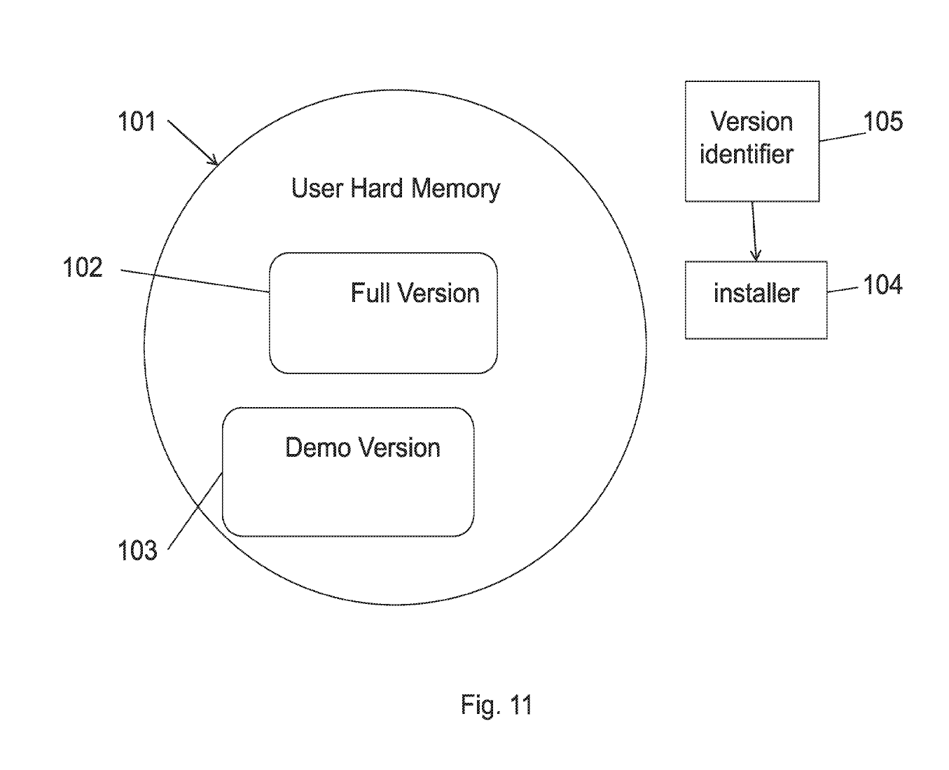

Reference is now made to FIG. 11, which is a simplified block diagram illustrating a further embodiment of the present invention. In general it is common for users of trading systems to try out the system first, carry out mock trades, compare systems of different manufacturers and generally learn the system. As a result there may be several versions of the trading platform on user's system 101, only one of which is the complete system 102. Others may be demonstration, or demo versions 103 and the like. The support system of the previous embodiments may be provided as an add-on or extension to the existing trading platform and thus needs to be installed on the correct version of the platform, namely the full version. Usually there is very little difference between the main and demo versions except that certain features have been disabled, or certain security modules are absent or the different versions connect to different servers.

Thus, in the embodiment of FIG. 11, an installer 104 which installs the support system, includes a version identifier 105 which is able to distinguish the full version from other versions. The version identifier reports to the installer which is then able to install the support system with the correct version.

The identifier may look out for the server that the trading platform connects to, or it may look for a security element which is only to be found in the main program, or it may look for implementation of a trade. If a real trade is implemented, as opposed to a dummy trade, then only the complete version can have achieved such a thing.

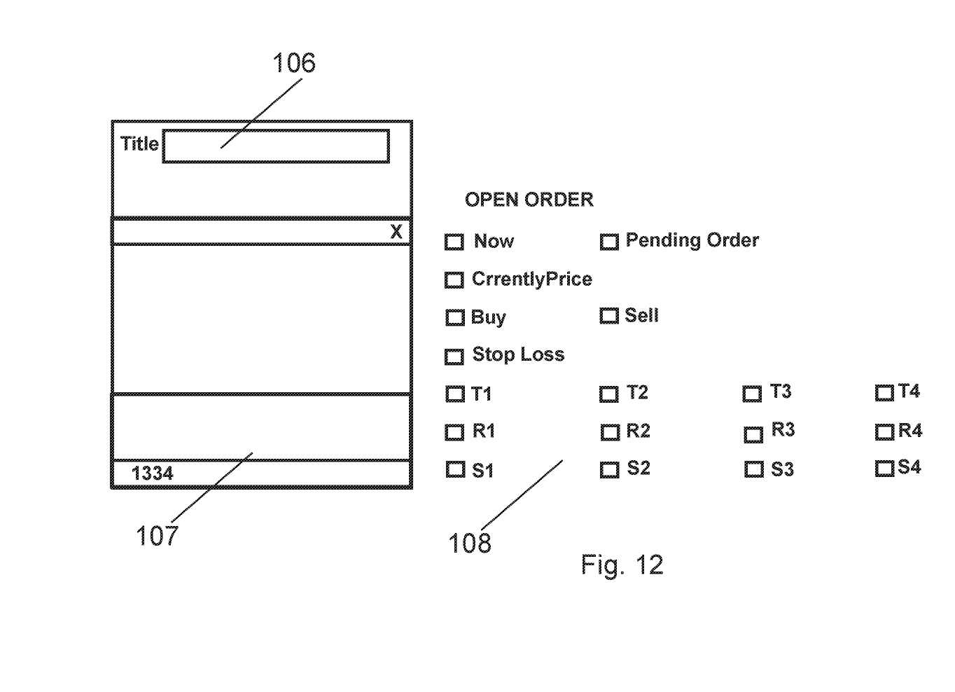

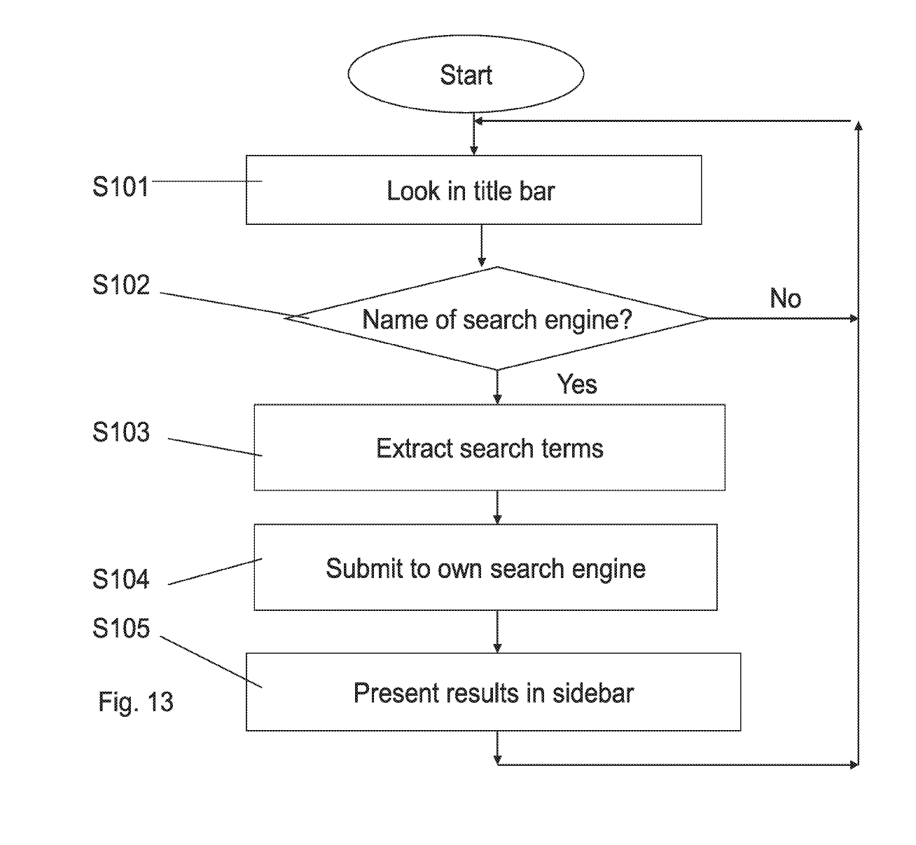

Reference is now made to FIG. 12 which shows an exemplary screen of the present embodiments. An alert header 106 indicates a particular line of derivatives. An alert 107 indicates certain information and a trading screen part 108 allows a trader to take particular actions simply by clicking boxes. The trader can set an order directly, or set a pending order. The order may be to buy or sell, and various parameters may be set. FIGS. 13-17 relate to a search engine embodiment.

Reference is now made to FIG. 13 which is a simplified flow chart illustrating an exemplary process for providing a search in relation to an Internet activity. In the case illustrated in FIG. 8, the Internet activity is an Internet search, although it will be appreciated that any activity that has the potential to generate keywords can be considered.

A small program such as an applet or the like operates in the background of a computing environment. The program looks for evidence of the activity in question in the title bar of the presently active window—S101. Generally, Internet activities generate windows of their own or at least modify the title bar of an existing window. In the case of an Internet search the search results are fed into a window which has the name of the search engine and the keywords used inserted into the title bar.

The applet looks for just such information in the title bar. As soon as it detects the name of a search engine in the title bar S102 it looks for any words following—which are presumed to be key words—S103. Thus the applet seizes the keywords of a search for which the results are already sitting with the user. The applet submits the keywords to its own search engine S104 and obtains its own results which are then presented in a sidebar S105.

The value of the applet's own search is that the additional search may be very different in scope from that provided by the main search engine. The supplementary search may for example be confined to local businesses in the vicinity of the user, or may be confined to academic publications or other specified types of literature. A user profile may be set up to contain the information for such customization. The user may be provided with the ability to actively customize the supplementary search, say via a user interface.

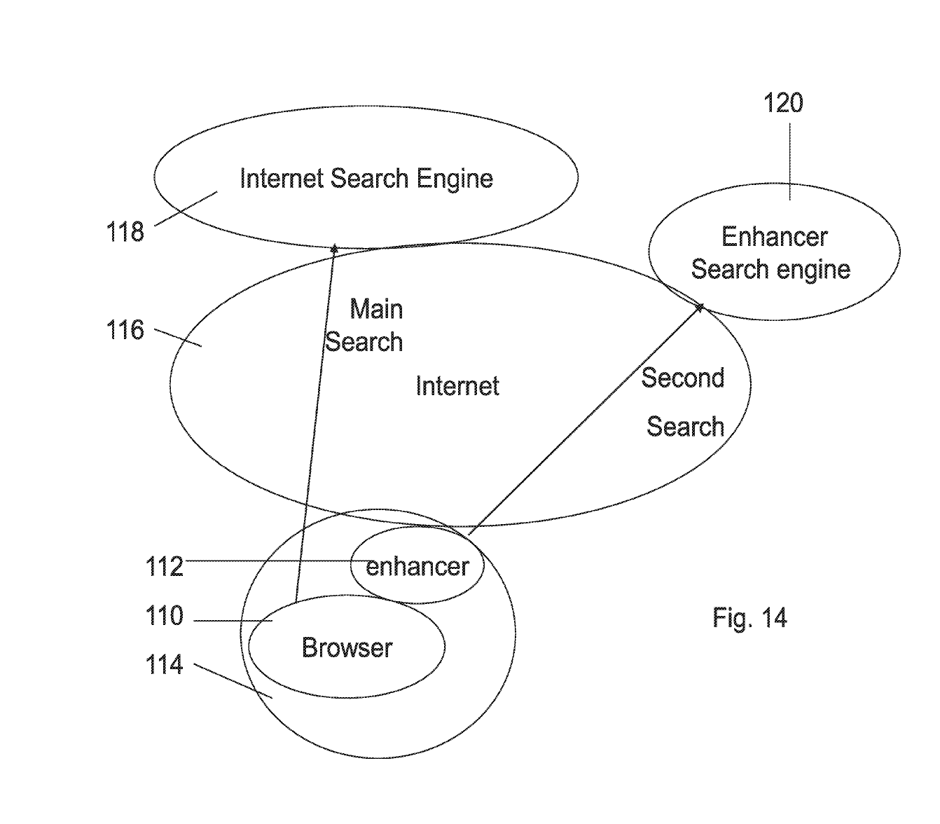

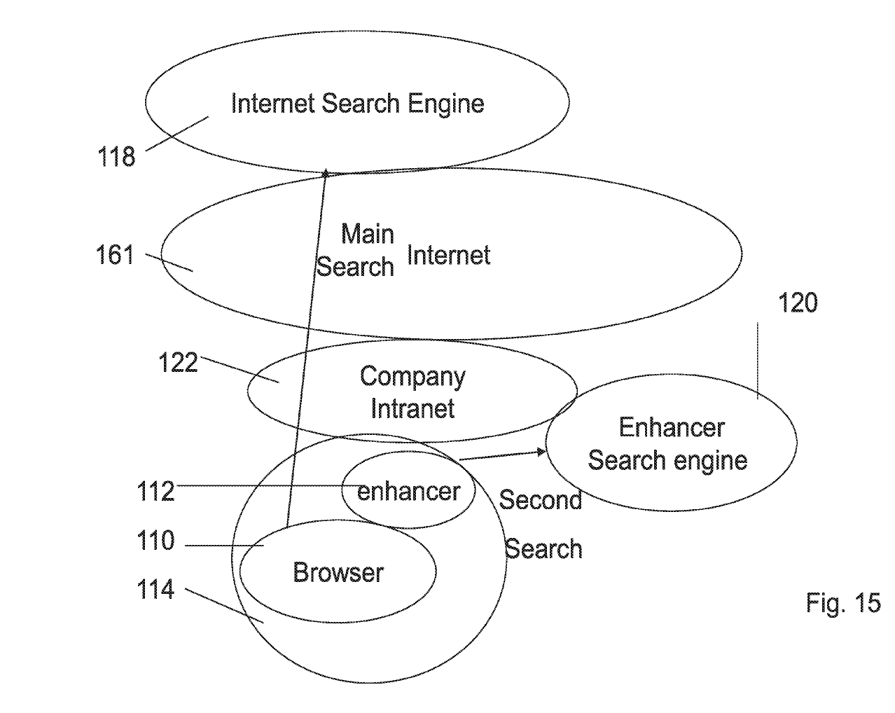

Referring now to FIG. 14, a user has a browser 110 and an enhancer applet 112 working together in his computing environment 114. The browser submits a search via a network such as the Internet 116 to an Internet search engine 118. The Internet search engine sends results back to the browser. The enhancer 112 identifies the results window and extracts the keywords, which are now submitted to its own search engine, here enhanced search engine 120. Typically the enhanced search engine may be accessed via the same network 116 as the main search engine 118. However in the embodiment shown in FIG. 15, the user is connected to the Internet via an Intranet 125 such as a proprietary company Intranet. The enhanced search engine is an internal search engine which is accessed only via the company intranet 125.

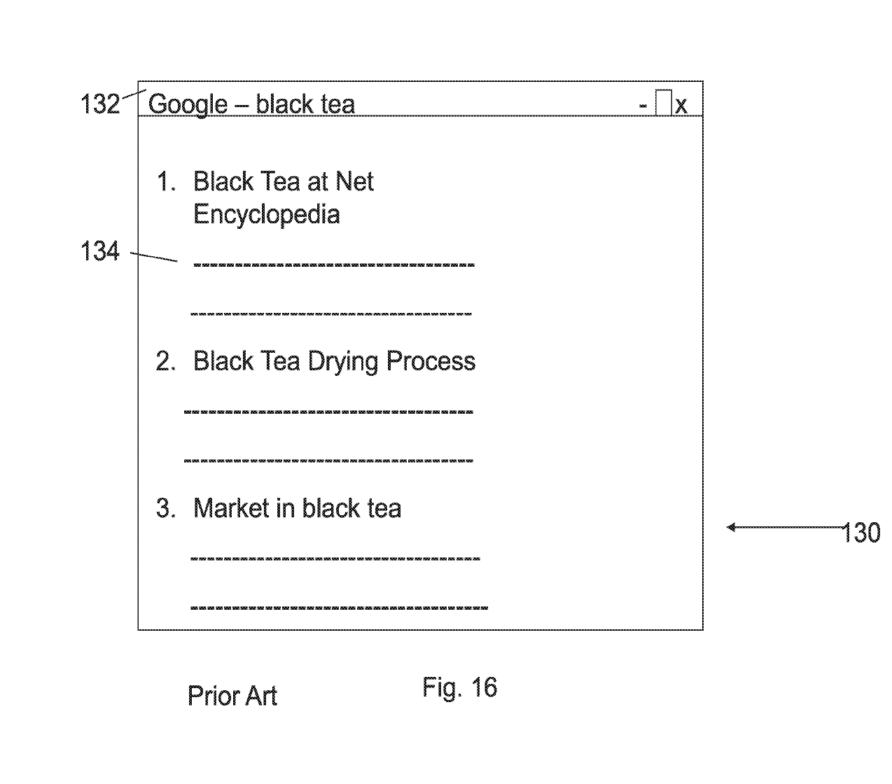

Reference is now made to FIG. 16, which is a simplified diagram illustrating a typical window in which search results are received. The window 130 has a title bar 132 which identifies an activity—in this case a search is indicated with the name of a widely used Internet search engine. The name of the search engine is followed by the key words used in the search.

In the main part 134 of the window a list of results retrieved by the search engine are shown.

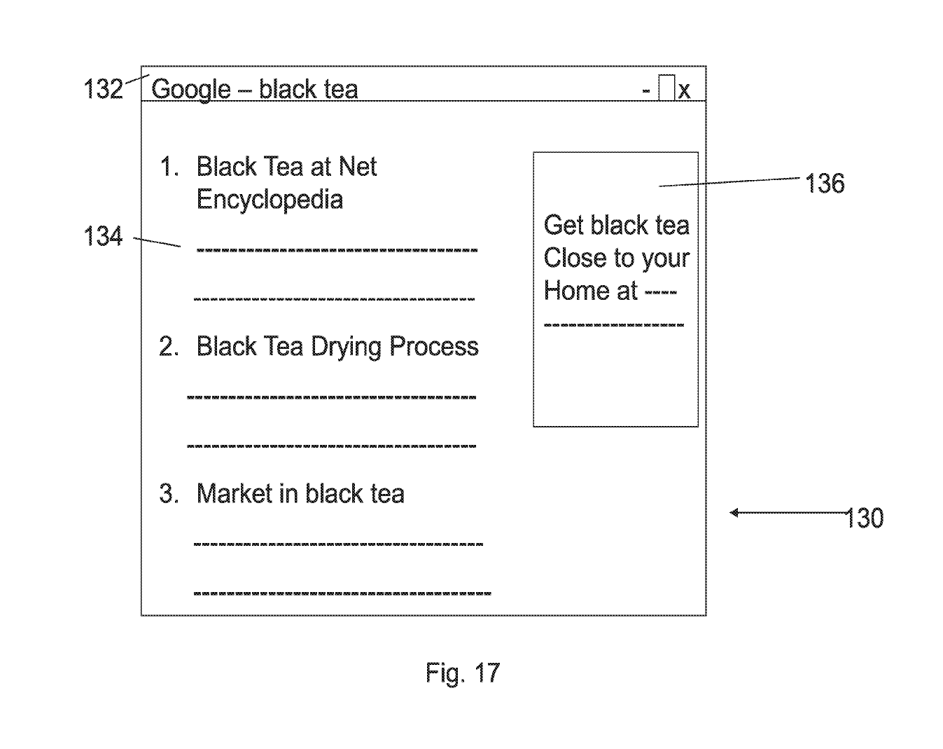

Reference is now made to FIG. 17 which illustrates a window such as that of FIG. 16 to which an embodiment of the present invention is applied. Parts that are the same as in FIG. 16 are given the same reference numerals and are not described again. A side bar 136 subsequently appears and shows the results of an enhanced search. In this case the enhanced search shows businesses geographically close to the user which are associated with the key words.

In another example, the activity may be word processing. The user types words which are recognized as keywords when they appear on the screen. The device submits the words to the search engine and, provided the user has suitably customized the user profile, the user sees a constantly running side bar with suggestions for information relevant to the material he is writing.

It is expected that during the life of a patent maturing from this application many relevant screen trading and statistical technologies will be developed and the scopes of the corresponding terms are intended to include all such new technologies a priori.

The terms “comprises”, “comprising”, “includes”, “including”, “having” and their conjugates mean “including but not limited to”.

The term “consisting of means “including and limited to”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A networked electronic information provision system for products with statistical complexity comprises:
(a) a first networked source, said first networked source receiving information about a plurality of financial products;
(b) a selector module, configured to select a given product from said plurality of financial products;
(c) a screen support system receiving information from said first networked source, said screen support system is configured to provide to each of a plurality of end users over a network a four part screen, said four part screen comprising:
(I) an alert screen part, said alert screen part providing users with a current alert regarding at least one first selected product from a second networked source;
(II) an alert timeline part, said alert timeline is configured to present previous alerts regarding said at least one first selected product from a second networked source, alongside a respective time of said previous alerts;
(III) a trading screen part, said trading screen part providing a trading screen to allow a user to view and interact with current trading positions of at least one second selected product from a third networked source;
(IV) a statistical screen part; said statistical screen part configured to present at least one statistical parameter relating to at least one third selected product.

2. The networked electronic information provision system for products with statistical complexity according to claim 1, wherein said statistical screen is configured to further display information about other products traded against said at least one first selected product.

3. The networked electronic information provision system for products with statistical complexity according to claim 1, wherein said screen support system is configured to support a fifth screen indicating markets that are currently available for product selection.

4. The networked electronic information provision system for products with statistical complexity according to claim 1, wherein said products are options and said at least one statistical parameter is a calculation related to the Black Scholes equation.

5. The networked electronic information provision system for products with statistical complexity according to claim 1, further comprising a currency strength calculator, wherein said products are currency derivatives, and said at least one statistical parameter is a currency strength calculated by said currency strength calculator based on a variation in respective exchange rates of said currency with each currency of a predetermined set of currencies.

6. The networked electronic information provision system for products with statistical complexity according to claim 5, wherein said variation is weighted according to trading volumes associated with each currency of said set.

7. The networked electronic information provision system for products with statistical complexity according to claim 10, wherein said currency strength calculator is further configured to modify said calculated strength on the basis of approach by said currency derivative to a trend line.

8. The networked electronic information provision system for products with statistical complexity according to claim 10, wherein said modification comprises considering a rate of approach to said trend line.

9. The networked electronic information provision system for products with statistical complexity according to claim 1, further comprises a module for enhancing network activity, implemented on an electronic processor, said module comprising: a titlebar watching unit configured to identify a predetermined activity by watching a currently active titlebar within a computing environment for an indication of the activity, and further configured to extract, from the titlebar, keywords relating to the activity; a search unit configured to submit the extracted keywords to a predetermined search engine and to receive results from said predetermined search engine; and a display unit for displaying at least one search result received from said predetermined search engine.

10. The networked electronic information provision system for products with statistical complexity according to claim 9, wherein said predetermined activity is network searching, and said currently active titlebar contains an indication of a network search engine and keywords following receipt of activity results from said network search engine, said network search engine being independent of said predetermined search engine.

11. The networked electronic information provision system for products with statistical complexity according to claim 10, comprising an updatable database from which to identify respective predetermined activities.

12. The networked electronic information provision system for products with statistical complexity according to claim 9, wherein said search unit comprises a user profile usable with said extracted keywords to provide customized searching on said predetermined search engine.

13. A method of providing electronic information for products with statistical complexity comprises:
(a) providing a first networked source:
(b) collecting information about a plurality of financial products to said first networked source;
(c) selecting a given product from said plurality of financial products;
(d) providing a screen support system;
(e) receiving information from said first networked source on said screen support system over a network
(f) generating a four part screen, said generating four part screen comprising:
(I) defining an alert screen part,
(II) providing users with a current alert regarding at least one first selected product from a second networked source;
(Ill) defining an alert timeline part;
(IV) presenting previous alerts regarding said at least one first selected product from a second networked source, alongside a respective time of said previous alerts;
(V) defining a trading screen part;
(VI) providing a trading screen to allow a user to view and interact with current trading positions of at least one second selected product from a third networked source;
(VII) defining a statistical screen part;
(VIII) presenting at least one statistical parameter relating to at least one third selected product.

14. The method according to claim 13, further comprises enhancing network activity, said enhancing network activity comprising:
(a) identifying a predetermined activity by watching a currently active titlebar within a computing environment for an indication of the activity, and further configured to extract, from the titlebar, keywords relating to the activity;
(b) submitting the extracted keywords to a predetermined search engine;
(C) receiving results from said predetermined search engine; and displaying at least one search result received from said predetermined search engine.

15. The method according to claim 13, further comprises customized searching comprising:
(a) providing a user client to a user, the user client monitoring user activity to extract keywords from said activity;
(b) carrying out searching based on a) keywords extracted by said user client and b) user profile information provided by said user client; and
(c) providing said results to said user as side information subsidiary to said activity.

16. The method according to claim 15, wherein said user client extracts said keywords from a titlebar of an active window.

17. The networked electronic information provision system for products with statistical complexity according to claim 1, further comprises a system for feeding news messages comprising:
(a) a message source configured to provide news messages, each message belonging to at least one subject, each subject denoted by a symbol;
(b) a feed source, connected to said message source and configured to provide a news feed for each symbol, to identify said messages by their respective symbols, and add said messages to a news feed corresponding to said respective symbol;
(c) a plurality of news feed clients connected over a network to said feed source, configured to allow a user to select a subject and thereby to receive said corresponding news feed.

18. The networked electronic information provision system for products with statistical complexity according to claim 17, comprising a statistical unit configured to continually calculate a range of statistical parameters and metastatistical parameters relating to said statistical parameters, said metastatistical parameters comprising statistical measures of success of respective statistical parameters under currently prevailing conditions, and wherein said statistical unit is configured to emphasize, on said statistical screen part, ones of said statistical parameters currently indicated by said metastatistical parameters as having highest measures of success.

19. The networked electronic information provision system for products with statistical complexity according to claim 1, wherein said trading screen part is configured to include trading lines from selected ones of respective exemplary traders, thereby to provide single screen mirror trading.

20. The networked electronic information provision system for products with statistical complexity according to claim 1, further comprises an installation system for installing an extension to an existing program, the extension working together with the existing program to add functions to the existing program, the existing program having a full version and multiple alternative versions, any of which can be present on a user's computer, the system comprising: a version identifier configured to look for at least one characteristic indicative of the full version, the absence of said characteristic being indicative of one of said alternative versions; and an installer for installing the extension with the full version of the program only, as identified by the version identifier.
